(19) United States
(12) Patent Application Publication
(10) Pub. No.: US 2004/0008273 A1
(43) Pub. Date: Jan. 15, 2004

(54) Method for controlling exposure of image-capturing apparatus

(76) Inventors: Kun-Chen Hsieh, Taipei (TW); Wen-Nan Chen, Taipei (TW)

Correspondence Address: MADSON & METCALF, GATEWAY TOWER WEST, SUITE 900, 15 WEST SOUTH TEMPLE, SALT LAKE CITY, UT, 84101

(21) Appl. No.: 10/462,492

(22) Filed: Jun. 16, 2003

(30) Foreign Application Priority Data
Jul. 9, 2002 (TW) 091115236

(51) Int. Cl. H04N 5/235

(52) U.S. Cl. 348/362

(57) ABSTRACT

A method for controlling exposure of an image-capturing apparatus via a shutter by operating a switch associated with the shutter is disclosed. Firstly, a first triggering signal is asserted in response to an enabling operation on the switch to open the shutter. Then, a second triggering signal is asserted in response to the enabling operation on the switch to close the opened shutter. Preferably, the method further comprises a step of automatically closing the shutter when a predetermined time period is up since the first triggering signal has been asserted and before the second triggering signal is asserted.

### FIELD OF THE INVENTION

The present invention relates to method for controlling exposure of an image-capturing apparatus, for example a digital camera.

### BACKGROUND OF THE INVENTION

A typical film-type camera comprises three essential parts, i.e. a main body, an optical unit and a film. The main body is essentially opaque. The optical unit comprises a plurality of delicate lens disposed in the front of the main body. The film is coated thereon sensitizer and arranged in the rear of the main body. When the light reflected from a photographed objective is focused by the lens onto the film, the sensitizer of the film is exposed under the light and chemically reacted to record a recognizable image.

The film-type camera further comprises a shutter arranged in the optical path for controlling exposure time. For the general purpose, when a release button associated with the shutter and disposed on the main body is pressed, the shutter is immediately opened for a predetermined short time period for allowing the light to enter the main body and be focused on the sensitizer along the optical path. After the predetermined short time period is up, the shutter will be automatically closed so as to control the light amount received by the film.

In a case where pictures of fireworks, running water, lightning or night-time traffic are to be taken, for example, a so-called B shutter speed setting is required. At the B shutter speed setting, the shutter stays open as long as the release button is pressed down, thereby obtaining a longer exposure time.

Although the B shutter speed setting provides a longer exposure time, there still exist some disadvantages. For example, the release button needs to be continuously pressed down until the exposure is satisfied. In addition, at such ultra-slow shutter speed settings, the camera is readily rocked due to the long holding time. Therefore, a tripod or another means for holding the camera steady is required while the exposure is being made. In order to overcome these drawbacks, a release cable is employed with a tripod to control the B shutter in either an open or a closed state. The release cable is well known in the art and need not be further described in detail herein. Such release cable, however, is also operated by unceasingly pressing down a button at one end thereof when the exposure is made. The operation by continuously pressing down a button is not user-friendly.

### SUMMARY OF THE INVENTION

It is an object of the present invention to provide a method for controlling exposure of an image-capturing apparatus so as to increase steadiness of the image-capturing apparatus when a relatively longer exposure is made.

It is an object of the present invention to provide a method for controlling exposure of an image-capturing apparatus, which is more user-friendly, compared with the conventional method.

In accordance with an aspect of the present invention, there is provided a method for controlling exposure of an image-capturing apparatus via a shutter by operating a switch associated with the shutter. Firstly, a first triggering signal is asserted in response to an enabling operation on the switch to open the shutter. Then, a second triggering signal is asserted in response to the enabling operation on the switch to close the opened shutter.

In an embodiment, the method further comprises a step of automatically closing the shutter when a predetermined time period is up since the first triggering signal has been asserted and before the second triggering signal is asserted.

In an embodiment, the switch is a release button. The enabling operation is pressing and then releasing the release button.

In an embodiment, the switch is mounted to a main body of the image-capturing apparatus. Alternatively, the switch is separated from the image-capturing apparatus and controls the shutter via a cable or wireless transmission.

Preferably, the image-capturing apparatus is a film-type camera.

Preferably, the method for controlling exposure of an image-capturing apparatus is applied to a B shutter speed setting.

In accordance with another aspect of the present invention, there is provided a method for controlling exposure of an image-capturing apparatus via a shutter and a switch associated with the shutter. Firstly, a first activating device of the switch is enabled to assert a first triggering signal to open the shutter. Then, a second activating device of the switch is enabled to assert a second triggering signal to close the shutter.

In an embodiment, the method further comprises a step of automatically closing the shutter when a predetermined time period is up since the first triggering signal has been asserted and before the second triggering signal is asserted.

In an embodiment, the first and the second activating devices are the same release button.

In an embodiment, the first and the second activating devices are is a first and a second release buttons, respectively.

In an embodiment, the first triggering signal is asserted by pressing and then releasing the first release button. The second triggering signal is asserted by pressing and then releasing the second release button.

In an embodiment, the first and the second activating devices are mounted to a main body of the image-capturing apparatus.

In an embodiment, each the first and the second activating devices is separated from the image-capturing apparatus and controls the shutter via a cable or wireless transmission.

In accordance with another aspect of the present invention, there is provided a method for controlling exposure of a film-type camera. The camera comprises a shutter and a release button for controlling the open/close status of the shutter. The method comprises the following steps. Firstly, the release button is pressed and then released to actuate the shutter to open. Secondly, the release button is pressed and then released to actuate the shutter to close during a predetermined time period. Afterwards, the shutter is automatically closed when the shutter is not actuated to close by pressing and then releasing the release button during the predetermined time period.

In an embodiment, the predetermined time period is adjustable.

The above objects and advantages of the present invention will become more readily apparent to those ordinarily skilled in the art after reviewing the following detailed description and accompanying drawings, in which:

### BRIEF DESCRIPTION OF THE DRAWINGS

FIGS. 1(a)˜1(c) are functional block diagrams illustrating three arrangement examples of the release buttons relative to the shutter for implementing the method according to the present invention; and

FIG. 2 is a flowchart illustrating steps of a method for controlling exposure of a film-type camera operated at a B shutter speed setting according to a preferred embodiment of the present invention.

### DETAILED DESCRIPTION OF THE PREFERRED EMBODIMENT

As previously described, when a film-type camera is operated at a B shutter speed setting, the release button needs to be continuously pressed until the exposure is satisfied. In order to avoid the disadvantages of the prior art, the present invention provides a method for controlling exposure of a film-type camera without continuously pressing the release button. According to the method, a triggering signal is asserted to open the shutter and another triggering signal is asserted to close the shutter.

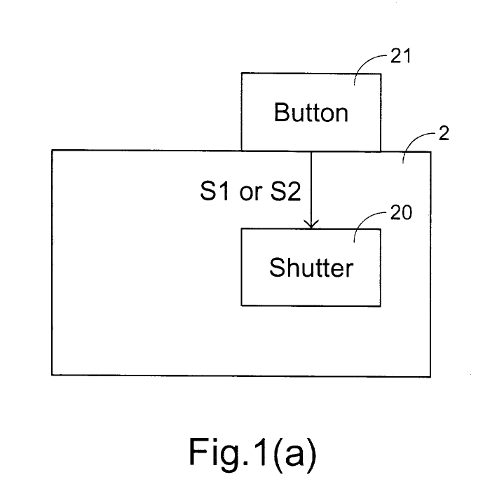

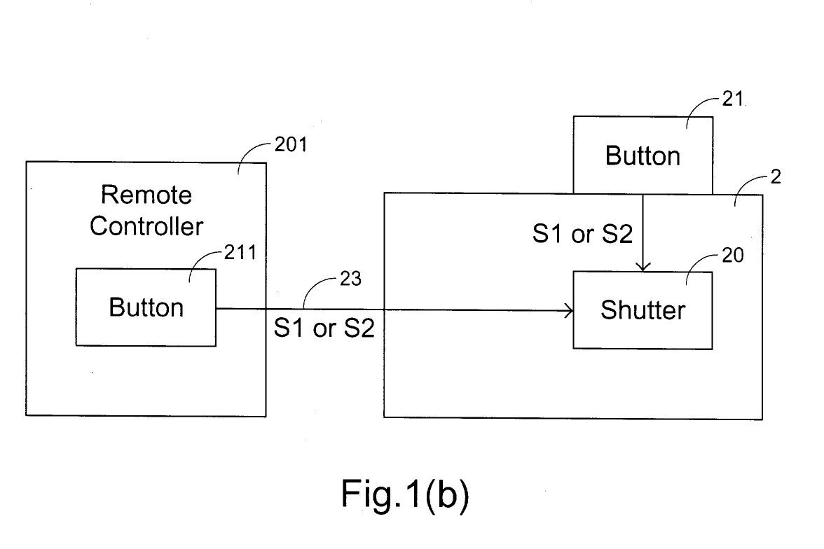

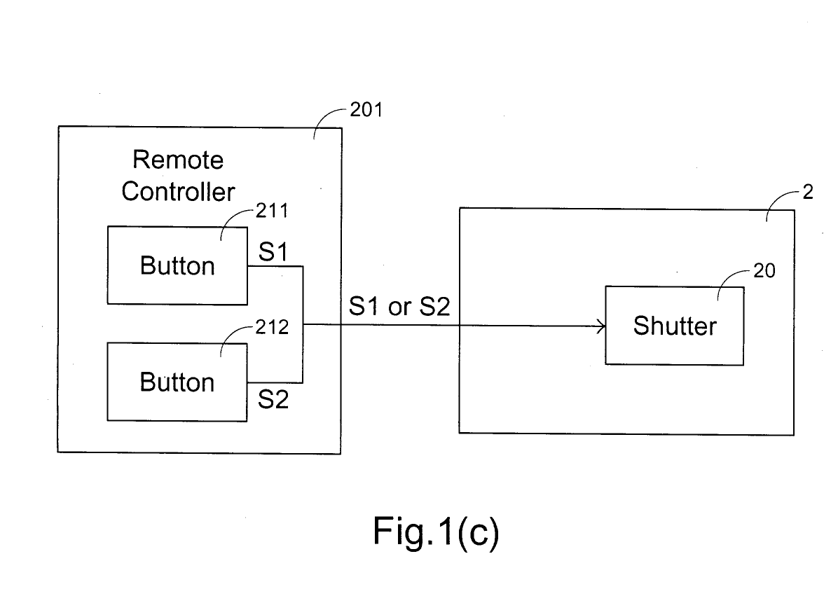

FIGS. 1(a)˜1(c) are functional block diagrams illustrating three arrangement examples of the release buttons relative to the shutter for implementing the method according to the present invention. In general, the shutter 20 is disposed in the camera housing 2. However, the release buttons are arranged in different manners.

For example, the release button 21 for B shutter speed setting is mounted onto the camera housing 2, as shown in FIG. 1(a). When the release button 21 is pressed and then released, a first triggering signal S1 is asserted to open the shutter, thereby allowing light to enter the camera. If the exposure time is considered to be sufficient, the user could press and then release the release button 21 again, and thus a second triggering signal S2 is asserted to close the shutter 20 so as to end exposure.

In addition to the button 21 mounted onto the camera housing 2, a remote controller or a remote switch 201 for controlling the open/close statuses of the shutter 20 via a release cable 23 can be provided, as shown in FIG. 1(b), and operated along with a tripod in order to avoid undesired rock. A release button 211 associated with the B shutter speed setting is disposed on the surface of the remote controller 201. When one of the release buttons 21 and 211 is pressed and then released, a first triggering signal S1 is asserted to open the shutter. By pressing and then releasing one of the release buttons 21 and 211 after exposure, a second triggering signal S2 is asserted to close the shutter so as to end exposure. Alternatively, the signal transmission via the release cable 23 can be substituted by wireless transmission.

Aside from opening and closing the shutter 20 by enabling the same release button 21 or 201 twice as described above, the open/close statuses of the shutter 20 can also be controlled by two different release buttons, e.g. the buttons 211 and 212 disposed on the surface of the remote controller 201, as shown in FIG. 1(c). When the release button 211 is pressed and then released, a first triggering signal S1 is asserted to open the shutter 20. By pressing and then releasing another release button 212 after exposure, a second triggering signal S2 is asserted to close the shutter 20.

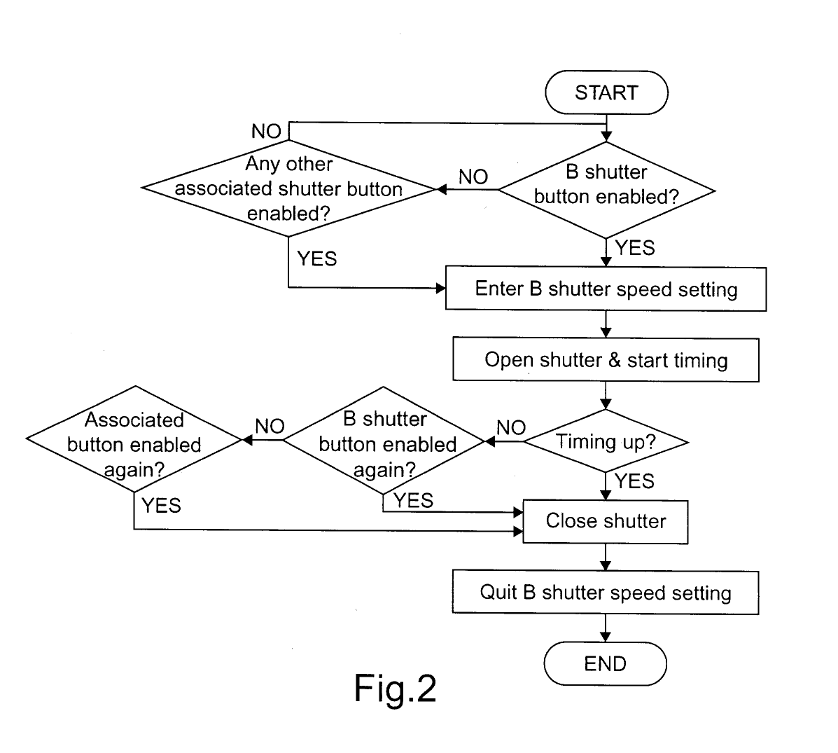

The end of exposure can also be determined according to a timing result without further pressing and then releasing the release button. For example, when the release button 21 or 201 is pressed and then released, the B shutter speed setting is entered, and a timing operation is started. When a predetermined period of time is up, the shutter 20 is automatically closed. Since the film in the camera might be over-exposed under long-term exposure, the timing operation is preferably performed for avoiding over-exposure. OF course, the exposure can be interrupted by asserting the second triggering signal S2 during the predetermined period of time. The method for controlling the exposure of a camera according to the present invention is illustrated with reference to the flowchart of FIG. 2 on the basis of the camera of FIG. 1(b).

It is understood that, in replace of continuously pressing a release button in the prior art, the open/close statuses of the shutter are activated by briefly pressing and then releasing a release button according to the present method. Therefore, the camera could maintain its steadiness even when a relatively longer exposure is made, and even when the means for holding the camera steady is absent. Thus, the method of the present invention is more user-friendly and cost-effective than that of the prior art.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for controlling exposure of an image-capturing apparatus via a shutter by operating a switch associated with said shutter, said method comprising:
asserting a first triggering signal in response to an enabling operation on said switch to open said shutter; and
asserting a second triggering signal in response to said enabling operation on said switch to close said opened shutter.

2. The method according to claim 1 further comprising a step of automatically closing said shutter when a predetermined time period is up since said first triggering signal has been asserted and before said second triggering signal is asserted.

3. The method according to claim 1 wherein said switch is a release button.

4. The method according to claim 3 wherein said enabling operation is pressing and then releasing said release button.

5. The method according to claim 1 wherein said switch is mounted to a main body of said image-capturing apparatus.

6. The method according to claim 1 wherein said switch is separated from said image-capturing apparatus and controls said shutter via a cable.

7. The method according to claim 1 wherein said switch is separated from a main body of said image-capturing apparatus and controls said shutter via wireless transmission.

8. The method according to claim 1 wherein said image-capturing apparatus is a film-type camera.

9. The method according to claim 8 being applied to a B shutter speed setting.

10. A method for controlling exposure of an image-capturing apparatus via a shutter and a switch associated with said shutter, said method comprising:
enabling a first activating device of said switch to assert a first triggering signal to open said shutter; and
enabling a second activating device of said switch to assert a second triggering signal to close said shutter.

11. The method according to claim 10 further comprising a step of automatically closing said shutter when a predetermined time period is up since said first triggering signal has been asserted and before said second triggering signal is asserted.

12. The method according to claim 10 wherein said first and said second activating devices are the same release button.

13. The method according to claim 10 wherein said first and said second activating devices are a first and a second release buttons, respectively.

14. The method according to claim 13 wherein said first triggering signal is asserted by pressing and then releasing said first release button.

15. The method according to claim 13 wherein said second triggering signal is asserted by pressing and then releasing said second release button.

16. The method according to claim 10 wherein said first and said second activating devices are mounted to a main body of said image-capturing apparatus.

17. The method according to claim 10 wherein each said first and said second activating devices is separated from said image-capturing apparatus and controls said shutter via a cable.

18. The method according to claim 10 wherein each of said first and second activating devices is separated from a main body of said image-capturing apparatus and controls said shutter via wireless transmission.

19. A method for controlling exposure of a film-type camera, said camera comprising a shutter and a release button for controlling the open/close status of said shutter, said method comprising steps of:
pressing and then releasing said release button to actuate said shutter to open;
pressing and then releasing said release button to actuate said shutter to close during a predetermined time period; and
automatically closing said shutter when said shutter is not actuated to close by pressing and then releasing said release button during said predetermined time period.

20. The method according to claim 19 wherein said predetermined time period is adjustable.
